(19) United States
(12) Patent Application Publication
(10) Pub. No.: US 2016/0050669 A1
(43) Pub. Date: Feb. 18, 2016

(54) A Method Performed in User Equipment in a Radio Network of Managing OVSF Codes, a Method Performed in a Network Node of Managing OVSF Codes, User Equipment for a Radio Network and a Network Node for a Radio Network

(71) Applicant: TELEFONAKTIEBOLAGET L M ERICSSON (PUBL), Stockholm (SE)

(72) Inventors: Sairamesh NAMMI, Kista (SE); Andres REIAL, Malmö (SE); Yi-Pin Eric WANG, Fremont, CA (US)

(21) Appl. No.: 14/780,256

(22) PCT Filed: Mar. 26, 2014
(86) PCT No.: PCT/SE2014/050363

§ 371 Date: Sep. 25, 2015

Related U.S. Application Data
(60) Provisional application No. 61/805,621, filed on Mar. 27, 2013.

(51) Int. Cl. H04W 72/04

(52) U.S. Cl. CPC H04W 72/0466

(57) ABSTRACT

The present disclosure relates to a method performed in User Equipment, UE, in a radio network, of managing OVSF codes. The method comprises receiving (Si3) information regarding at least one unused OVSF code, said information identifying at least one unused OVF code index and/or at least one spreading factor, and obtaining (P6) the at least one unused OVSF code based on the received information (Si3). The present disclosure further relates to a method performed in a network node, to a User equipment and to a network node.

### TECHNICAL FIELD

The present disclosure relates to a method performed in User Equipment in a radio network of managing spectrum resources and in particular managing of Orthogonal Variable Spreading Factor OVSF codes. The present disclosure further relates to a method performed in a network node of managing spectrum resources and in particular of managing OVSF codes.

The present disclosure also relates to a User Equipment for a radio network.

The present disclosure also relates to a User Equipment for a network node.

### BACKGROUND

During the last few years, cellular operators have started to offer mobile broadband based on WCDMA/HSPA. Further, fuelled by new devices designed for data applications, the end user performance requirements are steadily increasing. The large uptake of mobile broadband has resulted in heavy traffic volumes that need to be handled by High Speed Packet Access, HSPA, networks. Therefore, techniques that allow cellular operators to manage their spectrum resources more efficiently are of large importance.

One way to improve downlink performance would be to introduce support for 4-branch MIMO, multi flow communication, multi carrier deployment etc.

However, since improvements in spectral efficiency per link are approaching theoretical limits, the next generation technology is about improving the spectral efficiency per unit area. In other words, the additional features for HSDPA need to provide a uniform user experience to users anywhere inside a cell by changing the topology of traditional networks. Currently 3GPP has been working on this aspect of using heterogeneous networks.

Homogeneous Networks: A homogeneous network is a network of base stations, e.g. NodeBs, in a planned layout and a collection of user terminals in which all base stations have similar transmit power levels, antenna patterns, receiver noise floors, and similar backhaul connectivity to the data network. Moreover, all base stations offer unrestricted access to user terminals in the network, and serve roughly the same number of user terminals. Current wireless systems that come under this category are, for example, GSM, WCDMA, HSPA, LTE, Wimax.

Heterogeneous Networks: In heterogeneous networks, in addition to the planned or regular placement of macro base stations, several micro/pico/femto/relay base stations are deployed, as shown in FIG. 1. Note that the power transmitted by these micro/pico/femto/relay base stations is relatively small compared to that of macro base stations and can be up to 2 W, as compared to that of 40 W for macro base station. Such Low Power Nodes, LPN, are deployed to eliminate coverage holes in the homogeneous networks (using macro only) or improve capacity in hot-spots. Due to their lower transmit power and smaller physical size, micro/pico/femto/relay base stations can offer flexible site acquisitions.

Simulations show that using low power nodes in a macro cell offers load balancing, hence the huge gains in system throughout, as well as cell edge user throughput.

However, even though huge gains in terms of average sector throughput are achieved with the introduction of LPNs, the interference structure becomes more complex in heterogeneous networks. For example, when a UE is connected to an LPN, the individual UE link througput is impacted due to the interference of Macro Node power. In such networks, interference suppression using linear receivers, GRAKE, or interference cancellation with non-linear receivers i.e. IC with GRAKE front end, is a prerequisite for obtaining acceptable performance.

FIG. 2 shows the link performance when the UE which is connected to a LPN experiences a strong interference from the macro node. Note that the interference due to other nodes is modeled as additive white Gaussian noise. The total received interference from other nodes plus the thermal noise is assumed to have one-sided power spectral density No. The total received power from the serving node is denoted as Ior in FIG. 2. The ratio of Ior/No is often referred to as the geometry factor as it is related to the location of the UE relative to its serving node. A higher geometry factor typically means that the UE is close to the serving node, whereas a lower geometry factor typically means the UE is far away from the serving node.

It can be observed from the above that, without capable interference mitigation, there is a huge performance degradation with the macro interference. The performance loss is in the range of 100% in some geometries.

### Common High Speed Shared Control Channel, HS-SCCH, Orders

A new type of common H-RNTI, high-speed downlink shared channel radio network transaction identifier, is defined for use together with HS-SCCH orders. By using the same H-RNTI for many UEs, a common HS-SCCH order can be defined. This new UE H-RNTI needs to be informed to a group of UEs.

The HS-SCCH order is scrambled with the cell-specific downlink scrambling code in the same way as in existing 3GPP specifications. This means that HS-SCCH orders from a particular cell will only affect UEs that monitor HS-SCCH channels (i.e. HS-SCCH channelization codes) in that cell. In existing 3GPP specifications, the UEs monitor a number of HS-SCCH channels in the serving HS-DSCH cell and in any activated secondary serving HS-DSCH cells and up to one HS-SCCH channel in a non-serving cell (for triggering of enhanced serving cell change).

In case of UE-specific HS-SCCH orders, the order is acknowledged by the UE with an acknowledgement, ACK, code word in a hybrid automatic repeat request, HARQ-ACK, field on the high speed dedicated physical common control channel, HS-DPCCH. The UE never sends a non-acknowledgement, NACK in response to an HS-SCCH order. If the UE does not ACK the order, the NodeB can choose to retransmit the order, possibly with a higher transmit power, until an ACK is received from the UE (or until a maximum number of retransmissions has been reached).

A traditional GRAKE formulation uses maximum likelihood (ML) weights:

w=Rᵤ⁻¹h

where Ru is the impairment covariance. Estimating Ru based on the 10 common pilot channel, CPICH, symbols (SF256) per slot does often not provide very good performance due to the small number of available symbols, especially when smoothing over several TTIs is not an option since the interference changes from one TTI to another.

Hence, improved demodulation performance is desired.

### SUMMARY

As described above, the traditional GRAKE formulation uses maximum likelihood (ML) weights, based on estimating the impairment covariance matrix (Ru) of the de-spread symbol estimates. The impairment covariance has classically been the challenging term to estimate, due to the small number of demodulation common pilot channel, CPICH, symbols per slot. The solution is based on the insight that demodulation performance is improved if symbol positions from unused codes, e.g. unused HS-PDSCH codes, could be used for estimating Ru. Since the unused code indices changes dynamically (each scheduled TTI), the receiver does not know which of the codes are unused at a given TTI.

The present disclosure describes a UE, for example for a WCDMA/HSPA system with improved abilities to receive OVSF code indices, as well as a network node such as a NodeB capable of improved signaling OVSF code indices. In addition, methods performed in such a UE and a network node are comprised in the disclosure. In this disclosure, we show the method for performed in the network node such as a NodeB signals the unused code indices to the UE in order to enhance the performance of the UE, as well as showing such a NodeB and UE, and a method for operating the UE disclosed herein.

One embodiment of the present disclosure relates to a method performed in User Equipment, UE, in a radio network. The method comprises receiving information regarding at least one unused OVSF code and obtaining the at least one unused OVSF code based on the received information. The information identifies at least one unused OVF code index and/or at least one spreading factor. One advantage with this solution is that the User Equipment obtains knowledge about the unused codes in an OVSF code tree. Thereby, demodulation performance can be improved as unused codes, e.g. unused HS-PDSCH codes, could be used for estimating Ru, as described above.

In one option, the method further comprises a step of applying the unused OVSF codes in demodulation of signaling from a network such as a Node B. One advantage is that demodulation performance can be improved as the User Equipment can use unused codes in the orthogonal variable spreading factor, OVSF, code tree.

In one option, the method further comprises a step of receiving at least one OVSF code tree or information regarding the at least one OVSF code tree. The step of obtaining unused OVSF codes is based on the received at least one OVSF code tree or information regarding the at least one OVSF code tree. Thereby, as the User Equipment knows the least one OVSF code tree, a limited amount of information needs to be transmitted to the User Equipment in order to identify the at least one unused OVSF code index and/or at least one spreading factor.

In one option, the method further comprises a step of receiving mapping between the at least one OVSF code tree or information regarding the at least one OVSF code tree, and the received information. Thereby, as the User Equipment possesses mapping information, the amount of information which needs to be transmitted to the User Equipment in order to identify the at least one unused OVSF code index and/or at least one spreading factor can be reduced.

One embodiment of the present disclosure relates to a method performed in a network node. The method comprises obtaining unused OVSF codes, forming information regarding the unused OVSF codes, and transmitting the information regarding the unused OVSF codes to at least one User Equipment. The information regarding the unused OVSF codes identifies the unused OVSF codes by unused OVSF code indices and/or Spreading Factors, SFs.

One embodiment of the present disclosure relates to User Equipment, UE for a radio network. The UE comprises an antenna unit, a receive unit, Rx, and a transmit unit, Tx, connected to the antenna unit, a memory unit, and a control unit arranged to control the function of the receive unit and the transmit unit. The receive unit is arranged to receive information regarding unused OVSF codes. The control unit is arranged to obtain unused Orthogonal variable spreading factor, OVSF, codes based on the information regarding unused OVSF codes. The unused OVSF codes are identified by unused OVSF code indices and/or Spreading Factors, SFs.

In one option, the information regarding unused OVSF codes comprises at least one individual OVSF code index.

In one option, the information regarding unused OVSF codes comprises unused OVSF code pool indices or a subset of unused OVSF code pool indices. Then, all OVSF code indices need not be signaled to the User Equipment, It is sufficient that the for example a first index and/or a last index in a OVSF code pool is comprised in the information regarding unused OVSF codes.

In one option, the information regarding unused OVSF codes relates to at least one given TTI. Thereby, as the information regarding unused OVSF codes relates to at least one given TTI, the user equipment knows the unused codes in the OVSF code tree during the current or future TTI(s).

In one option, the information regarding unused OVSF codes comprises a TTI for which the information regarding the unused OVSF code is applicable.

In one option, the UE has information related to at least one TTI for which the information regarding the unused OVSF code is applicable.

In one option, the spreading factor, SF, is predefined.

In one option, the memory unit is arranged to store at least one OVSF code tree and/or information regarding the OVSF code tree.

In one option, the User Equipment further has information related to mapping between the OVSF code tree or information regarding the OVSF code tree, and signalling values.

In one option, the User Equipment is arranged to receive the mapping information using higher level signaling such as a second HS-SCCH order or a second RNC RRC message.

In one option, the control unit is further arranged to apply the unused OVSF codes in demodulation of signaling from a network, such as a NodeB.

One embodiment of the present disclosure relates to a network node for a radio network. The network node comprises a receive unit, a transmit unit controlled by means of a control unit, and a memory unit. The control unit has knowledge about unused Orthogonal variable spreading factor, OVSF, codes at the moment or during coming TTIs. The control unit is arranged to form information regarding unused OVSF codes based on the unused OVSF codes. The information regarding unused OVSF codes identifies the unused OVSF codes by unused OVSF code indices and/or Spreading Factors, SFs. The transmit unit is arranged to transmit the information regarding the unused OVSF codes to at least one User Equipment.

In one option, the network node is arranged to signal a first dedicated or common HS-SCCH order comprising the information regarding unused OVSF codes.

In one option, the network node is arranged to signal a higher level signaling comprising the information regarding unused OVSF codes.

In one option, the network node is arranged to signal a first RNC RRC message comprising the information regarding unused OVSF codes.

In one option, the network node further has information related to mapping between the OVSF code tree or information regarding the OVSF code tree, and signalling values.

In one option, the network node further is arranged to transmit and/or receive the mapping information using higher level signaling such as a second HS-SCCH order or second RNC RRC messages.

In one option, the network node is a Node B.

### BRIEF DESCRIPTION OF THE DRAWINGS

The disclosure will be described in more detail in the following, with reference to the appended drawings, in which

FIG. 1 shows a typical deployment of low power nodes in a heterogeneous network, and

FIG. 2 shows link performance illustrating performance degradation when the UE is in cell range expansion zone, and

FIG. 3 shows one example of a signaling scheme for obtaining at least one unused OVSF code,

FIG. 4 shows a block diagram of one example of a UE,

FIG. 5 shows a block diagram of one example of a network node such as a NodeB, and

FIG. 6 shows segments of an OVSF code tree used in WCDMA.

FIG. 7 is a block diagram of an example of a UE control unit.

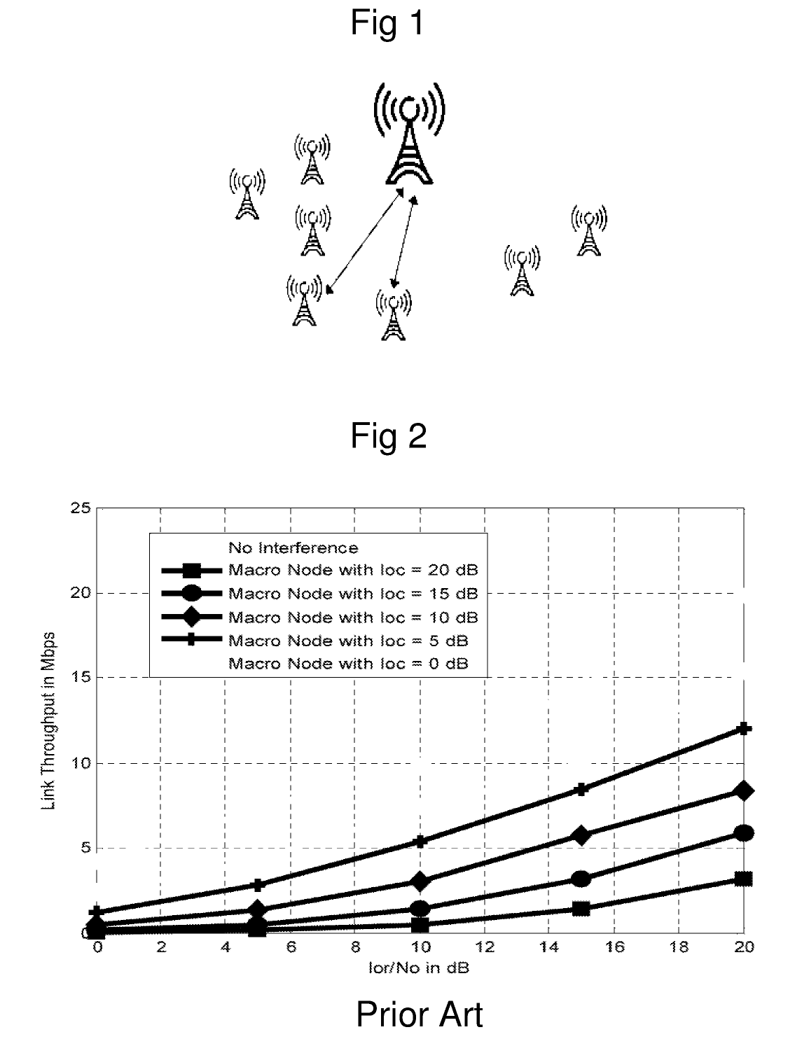

### DETAILED DESCRIPTION

Embodiments will be described more fully hereinafter with reference to the accompanying drawings, in which embodiments are shown. The UE, NodeB and the methods may, however, be embodied in many different forms and should not be construed as being limited to the embodiments set forth herein. Like numbers in the drawings refer to like elements throughout.

The terminology used herein is for the purpose of describing particular embodiments only, and is not intended to limit the disclosure.

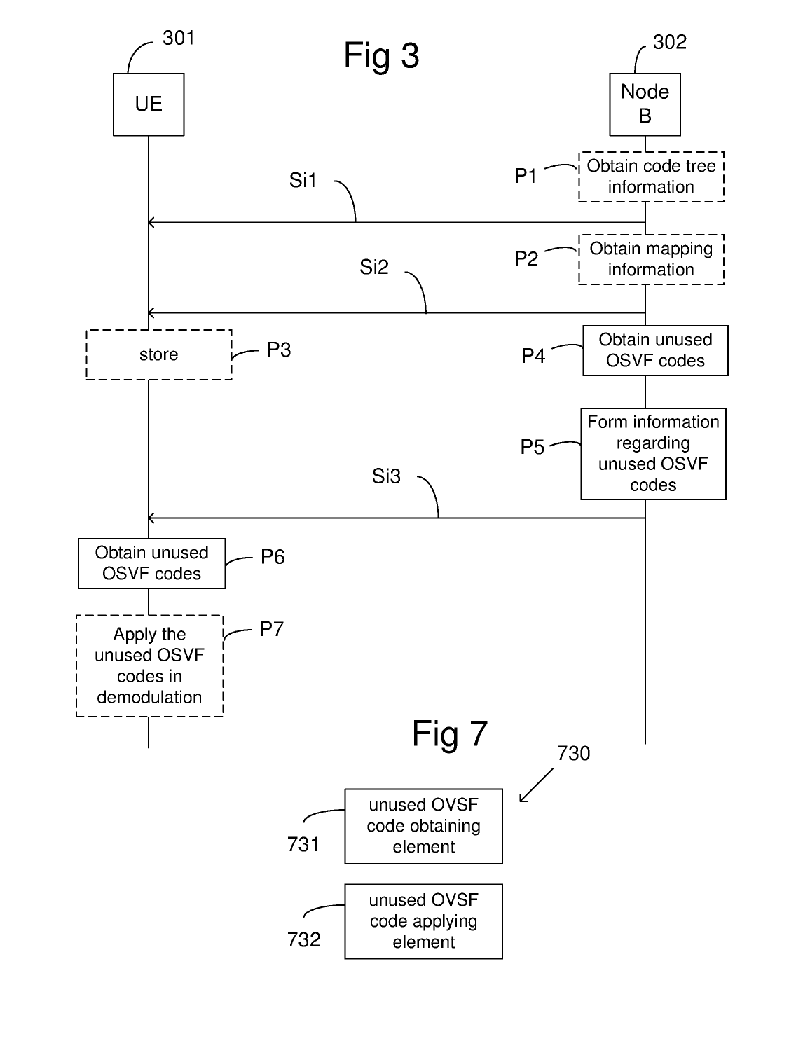

In FIG. 3, a signaling scheme for obtaining at least one unused OVSF code in a user equipment is illustrated. In the illustrated signaling scheme a network node 302, such as Node B in a radio network, obtains P4 unused OVSF codes. Information regarding the obtained unused OVSF codes is formed. The information identifies the unused OVSF codes by unused OVSF code indices and/or Spreading Factors, SFs. The information regarding the unused OVSF codes is transmitted Si3 to at least one User Equipment.

A User Equipment 301, UE, in a radio network receives Si3 information regarding at least one unused OVSF code. The information identifies at least one unused OVSF code index and/or at least one spreading factor. The at least one unused OVSF code is obtained P6 based on the received information Si3. In an optional step the unused OVSF codes are applied P7 in demodulation of signaling from a network such as a Node B.

Demodulation performance can be improved when using for example unused codes in the high speed physical data shared channel, HS-PDSCH codes (SF16), i.e. with Spreading Factor 16, or other unused codes in the orthogonal variable spreading factor, OVSF, code tree.

The demodulation performance can be improved if the receiver could use unused high speed physical data shared channel, HS-PDSCH codes (SF16), i.e. with Spreading Factor 16, or other unused codes in the orthogonal variable spreading factor, OVSF, code tree. But since the unused code indices in the downlink change dynamically, at each scheduled TTI, the receiver does not know the unused codes in the OVSF code tree during the current or future TTI(s).

The information regarding at least one OVSF code is in one example obtained P6 from an OVSF code tree. The OVSF code tree is for example used in WCDMA. In this disclosure, one principle is to use common or dedicated High speed shared control channel, HS-SCCH, orders to signal unused code indices at a given Transmit Time Interval, TTI, to enable improved UE receiver performance. The phrase “common HS-SCCH order” refers to the fact that the order is broadcast to a number of UEs, possibly as broadcast to all UEs in a cell. The given TTI is in one example implicitly understood, i.e. the UE knows which TTI(s) to apply the common HS-SCCH orders to. In one example, the given TTI(s) are explicitly signaled to the UE.

In one example, individual unused code indices are signaled. In one example, an unused “code pool”, or a subset of an unused code pool is predefined or signaled. The individual unused code indices or the unused “code pool” or the subset of an unused code pool, is in one example signaled by means of common HS-SCCH orders. The individual unused code indices or the unused “code pool” or the subset of an unused code pool is in one example signaled means of other higher layer signaling, such as Radio Network Controller Radio Resource Control, RNC RRC, messages. Unused code indices or unused code pools or subsets of unused code pools are signaled for a given TTI or a number of given TTIs. The TTI(s) in question are either implicitly signaled by means of an order being for a predefined TTI(s), or the TTI(s) in question are signaled explicitly. If signaled explicitly, then for example, the first and the last of the TTIs concerned are signaled.

A possible unused code pool is predefined or signaled via higher-layer signaling such as HS-SCCH orders or RNC RRC messages.

The signaling is either for all of the UEs in a cell, or for a subset of the UEs in the cell, where the subset can be one UE only. For example, the subset of UEs which receive such signaling are UEs conforming to Universal Mobile Telecommunications System/Wideband Code Division Multiple Access/High Speed Downlink Packet Access, UMTS/WCDMA/HSPA Rel-12 standard. As another example, the subset of UEs which receive such signaling are UEs having a certain receiver category or receiver capability or receiver identity, i.e. UE identity.

In the illustrated example of FIG. 3, the Node B obtains P1 in one example at least one OVSF code tree or information regarding the at least one OVSF code tree. The at least one OVSF code tree or information regarding the at least one OVSF code tree Si1 is in one example transmitted to the UE 301.

The UE 301 receives Si1 at least one OVSF code tree or information regarding the at least one OVSF code tree. The UE 301 stores P3 the at least one OVSF code tree or information regarding the at least one OVSF code tree. The step of obtaining unused OVSF codes is in this example based on the received at least one OVSF code tree or information regarding the at least one OVSF code tree.

In the illustrated example of FIG. 3, the Node B obtains P2 in one example mapping between the at least one OVSF code tree or information regarding the at least one OVSF code tree, and the signaled Si3 information regarding unused codes. Information related to the mapping between the at least one OVSF code tree or information Si2 regarding the at least one OVSF code tree, and the signaled Si3 information regarding unused OVSF codes is in one example transmitted to the UE 301.

The UE 301 receives the information related to the mapping between the at least one OVSF code tree or information Si2 regarding the at least one OVSF code tree, and the signaled Si3 information regarding unused OVSF codes. The UE 301 stores P3 information related to the mapping between the at least one OVSF code tree or information Si2 regarding the at least one OVSF code tree, and the signaled Si3 information regarding unused OVSF codes. The step of obtaining unused OVSF codes is in this example based on the received information related to the mapping between the at least one OVSF code tree or information Si2 regarding the at least one OVSF code tree, and the signaled Si3 information regarding unused OVSF codes.

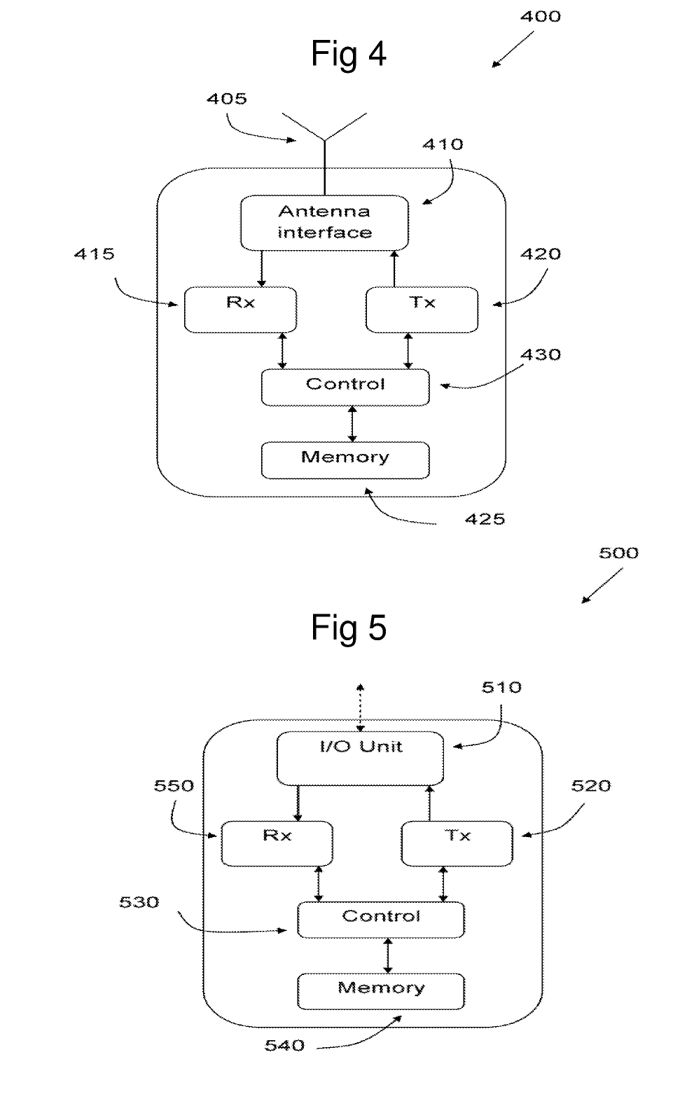

FIG. 4 shows a schematic block diagram of a UE 400. In one example, the UE is configured for operation in a WCDMA/HSPA system. As shown in FIG. 4, the UE 400 comprises an antenna unit 405, a receive unit, Rx, 450, a transmit unit, Tx, 420, a memory unit 440, and a control unit 430. The antenna unit 405 is connected to an antenna interface 410. The antenna interface 410 is used to connect the receive unit, “Rx”, 450 and the transmit unit, “Tx”, 420 to the antenna unit 405. The function of the receive unit and of the transmit unit is controlled by means of the control unit 430, which uses a memory unit 440. The antenna unit 405, the antenna interface 410 and the receive unit 450 are used to receive the information regarding the unused codes.

The receive unit is arranged to receive information regarding unused OVSF codes. The control unit 430 is arranged to obtain unused Orthogonal Variable Spreading Factor, OVSF, codes based on the received information regarding unused OVSF codes. The unused OVSF codes are identified by unused OVSF code indices and/or Spreading Factors, SFs.

The memory unit is in one example be used to store OSVF code trees or information regarding them. The control unit is in one example used to understand the information regarding unused codes, indices and/or SFs as transmitted from the network, e.g. the NodeB. In one example, the control unit 430 is arranged to apply the unused OVSF codes in demodulation of signaling from a network, such as a NodeB.

The receive unit is in one example arranged to receive a higher level signaling comprising the information regarding unused OVSF codes. The receive unit is in one example arranged to receive a first Radio Network Controller Radio Resource Control, RNC RRC, message comprising the information regarding unused OVSF codes. The receive unit is in one example arranged to receive a first dedicated or common HS-SCCH order comprising the information regarding unused OVSF codes.

The information regarding unused OVSF codes comprises in one example at least one individual OVSF code index. The information regarding unused OVSF codes comprises unused OVSF code pool indices or a subset of unused OVSF code pool indices. The information regarding unused OVSF codes relates in one example to at least one given TTI.

The information regarding unused OVSF codes comprises in one example a TTI for which the information regarding the unused OVSF code is applicable. In one example, the User Equipment has information related to at least one TTI for which the information regarding the unused OVSF code is applicable.

In one example, the information regarding unused OVSF codes comprises the spreading factor, SF. In an alternative example, the spreading factor, SF, is predefined.

In one example, the User Equipment further has information related to mapping between the OVSF code tree or information regarding the OVSF code tree, and signalling values. In one example, the User Equipment is arranged to receive the mapping information using higher level signaling such as a second HS-SCCH order or a second RNC RRC messages.

In FIG. 7 a control unit 730 of a user equipment is illustrated. In one example, the user equipment is arranged to operate as described in relation to FIG. 4.

The control unit 730 comprises an unused OVSF obtaining element 731 arranged to obtain unused Orthogonal Variable Spreading Factor, OVSF, codes based on the received information regarding unused OVSF codes. The unused OVSF codes are identified by unused OVSF code indices and/or Spreading Factors, SFs. In one example, the control unit 730 comprises an unused OVSF code applying element 732 arranged to apply the unused OVSF codes in demodulation of signaling from a network, such as a NodeB.

FIG. 5 shows a schematic block diagram of a network node 500 for a radio network, comprising a receive unit (“Rx”) 550 and a transmit unit 520 (“Tx”) controlled by means of a control unit 530, and a memory unit 540. In one example, the network node is a NodeB.

As shown in FIG. 5, a network node exemplified as a NodeB 500 comprises an I/O unit 510, which is used to communicate with other units in the system, e.g. one or more UEs via wireless communication, and higher nodes via wireless or wired communication. The I/O unit 510 connects to the receive unit 550 and the transmit unit 520. The function of the receive unit 550 and of the transmit unit 520 is controlled by means of the control unit 530, which uses the memory unit 540. The control unit 530 is in one example used to see which OVSF codes that are not used at the moment or during coming TTIs, as well as to format the signaling to the UEs. The memory unit 440 is in one example arranged to store at least one OVSF code tree and/or information regarding the at least one OVSF code tree.

The control unit 530 has knowledge about unused Orthogonal variable spreading factor, OVSF, codes at the moment or during coming TTIs. The control unit 530 is arranged to form information regarding unused OVSF codes based on the unused OVSF codes. The information regarding unused OVSF codes identifies the unused OVSF codes by unused OVSF code indices and/or Spreading Factors, SFs. The transmit unit 530 is arranged to transmit the information regarding the unused OVSF codes to at least one User Equipment.

The network node 500 is in one example arranged to signal a first dedicated or common HS-SCCH order comprising the information regarding unused OVSF codes. The network node is in one example arranged to signal a higher level signaling comprising the information regarding unused OVSF codes. The network node is in one example arranged to signal a first RNC RRC message comprising the information regarding unused OVSF codes.

The information regarding unused OVSF codes comprises in one example at least one individual OVSF code index. The information regarding unused OVSF codes comprises in one example unused OVSF code pool indices or a subset of unused OVSF code pool indices. The information regarding unused OVSF codes relates in one example to at least one given TTI. The information regarding unused OVSF codes comprises in one example a TTI for which the information regarding the unused OVSF code is applicable. The information regarding unused OVSF codes comprises in one example information regarding the spreading factor, SF.

The network node has in one example information related to at least one TTI for which the information regarding the unused OVSF code is applicable. The network node has further in one example information related to mapping between the OVSF code tree or information regarding the OVSF code tree, and signalling values. The network node is then in one example further arranged to transmit and/or receive the mapping information using higher level signaling such as a second HS-SCCH order or second RNC RRC messages.

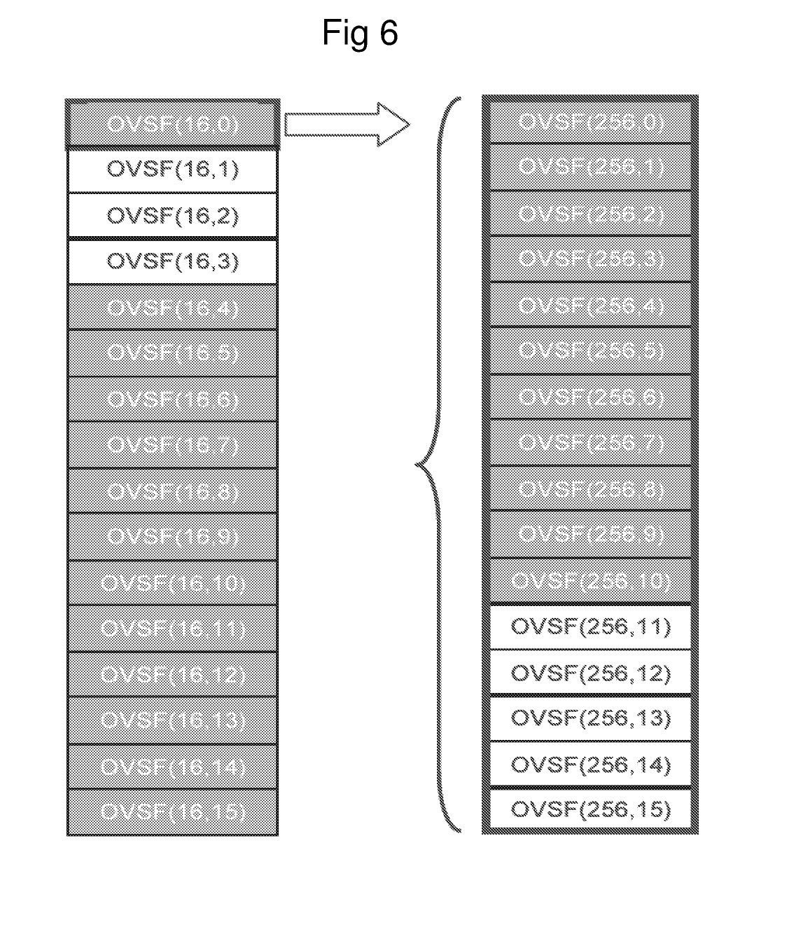

FIG. 6 illustrates one example of some segments of a OVSF code tree. The illustrated OVSF code tree segments are used in WCDMA. The first number in the parentheses indicates the spreading factor (SF) and the second number indicates the code index, (CI). As shown, there are 16 codes at SF 16. Also shown, for any root code at SF 16, there are a number of “descendant codes” at a higher SF. For example, as shown in FIG. 3, SF 16 code OVSF(16,0) has 16 descendant codes at SF 256. If a descendant code at a higher SF is used, the root code at a lower SF is no longer considered unused.

Different Orthogonal variable spreading factor, OSVF, code assignment embodiments by which control channels (e.g. C-PICH, PCH, HS-SCCH, etc) are assigned comprises in one example assigning from the top of the tree. Different Orthogonal variable spreading factor, OSVF code assignment embodiments by which data channels are assigned comprises in one example assigning from the bottom of the tree. Control channels use in one example a high SF. The data channel(s) uses in the illustrated example SF 16. Circuit-switched channels such as voice channels use also in one example high SF and can be assigned from the top. In the illustrated example of FIG. 3, some SF codes are shaded. This indicates that in the example of FIG. 3, the shaded SF codes are used, whereas non shaded SF codes are not shaded.

In one example, a code index which indicates a specific index for a given Spreading Factor, SF is signaled. If for example “5” is signaled, this means (SF, 5), where it is predefined or signaled previously that, for example, the SF=16. As an alternative, the signaled code index indicates the first unused index for a given or signaled SF, as will be explained below.

The SF in question is in one example pre-defined or signaled in advance, or signaled together with the code indices.

In embodiments, the network, e.g. the NodeB, signals the starting index of the unused codes. For example, if the network schedules two users, say UE1 and UE2 with code indices 2-4 and 5-8 respectively, then the network will send the unused code index 9. Such an unused code index is sent to one or more scheduled UEs (e.g. UE1 or UE2), or a group of UEs. The group of UEs conform to certain release of the standard, having a certain receiver category or receiver capability or receiver/UE identity. Once the UE receives this information, it will assume codes 9 from 15 are un-used. Hence only 4 bits are needed to indicate the starting position of un-used code index.

In one embodiment, the network, e.g. the NodeB, does not signal all the indices of the unused codes. This is due to the fact that having access to a number, for example, 1-4 unused SF 16 codes will also be of use. Naturally, SF=16 is only an example which can be replaced by another SF number. Thus, in this case, it is sufficient to signal indicators of whether, for example, OVSF(16,1), OVSF(16,2), OVSF(16,3), OVSF(16,4) are used. As described earlier, the possible unused code pool, in this example OVSF (16,1)-(16,4) is, for example, predefined or signaled via higher-layer signaling such as another HS-SCCH order or RNC RRC message(s).

All the valid cases for these examples are listed below:
Case 1: only OVSF(16,1) is unused.
Case 2: both OVSF(16,1) and OVSF(16,2) are unused.
Case 3: OVSF(16,1), OVSF(16,2), and OVSF(16,3) are unused.
Case 4: OVSF(16,1), OVSF(16,2), OVSF(16,3), and OVSF(16,4) are unused.

As can be seen, in this case, only two bits are needed to signal to the UE which of these four cases that is valid.

For a given SF, e.g. SF 16, a NodeB scheduler goes in one example for an aggressive code assignment schemes in which it “gives out” all 15 codes of that particular SF (i.e. OVSF(16,1) to OVSF(16,15)) to support one or more users. In that case, there is no unused code available at SF 16. However, some of the descendant codes from, e.g., OVSF(16,0) may be available. For example, the last descendant codes on that branch, OVSF(256,12), OVSF(256,13), OVSF(256,14), OVSF(256,15) might be unused. Thus, in such a case, one or more bits are in one example used to indicate which part of the code tree the unused code signaling is applied to. In one example, one bit is used to signal whether it is OVSF(16,1), OVSF(16,2), OVSF(16,3), and OVSF(16,4) or OVSF(256,12), OVSF(256,13), OVSF(256,14), OVSF(256,15) that the unused code signaling is referring to. The mapping between the parts of the code tree and signaling value is in one example defined using higher-layer signaling such as another HS-SCCH order or RNC RRC messages. In different embodiments, such higher-layer signaling is semi-static, or it is updated on a TTI-basis or at a slower pace. Then, using one of the two versions shown above, either four additional bits (as in the example where the first free code index was signaled) or two additional bits (as in the example where a sub-set of up to four free codes were signaled) are in one example used to signal which codes on that specific part of that code tree is unused.

In yet another case, the OVSF code tree nodes currently defined as the potential unused code pool may be determined by the scheduler dynamically, at the time scale of tens of milliseconds slower than at the TTI-rate, and signaled via higher-layer signaling such as HS-SCCH or RNC RRC signaling. For example, if the scheduler chooses to exclude the OVSF(16,1) code from HS-PDSCH scheduling, OVSF(64,4-7) is in one example defined as the code set that the unused code signaling will refer to.

Thus, a NodeB has been disclosed which is adapted to detect unused OVSF codes by index and/or SF and which is adapted to signal indexes and/or SF for the unused OVSF codes to the UE using the techniques described above.

Further, a UE has been disclosed adapted to receive the signaling as described above regarding unused OVSF codes. The UE understands the signaling and apply it in demodulation of signaling from the network, e.g. the NodeB.

In the drawings and description, there have been disclosed exemplary embodiments. However, many variations and modifications can be made to these embodiments without substantially departing from the principles of the present disclosure. Accordingly, although specific terms are employed, they are used in a generic and descriptive sense only and not for purposes of limitation.

The disclosure is not limited to the examples of embodiments described above and shown in the drawings, but may be freely varied within the scope of the disclosure herein.

1. A method performed in a User Equipment (UE) in a radio network, of managing Orthogonal Variable Spreading Factor (OVSF) codes, the method comprising:
receiving information regarding at least one unused OVSF code, said information identifying at least one of: at least one unused OVSF code index; and at least one spreading factor; and
obtaining the at least one unused OVSF code based on the received information, thereby enabling using unused OVSF codes in demodulation of signaling information received from the radio network.

2. The method of claim 1, further comprising a step of applying the unused OVSF codes in demodulation of signaling information received from the radio network node.

3. The method of claim 1, further comprising a step of receiving at least one OVSF code tree or information regarding the at least one OVSF code tree, wherein the obtaining of unused OVSF codes is based on the received at least one OVSF code tree or information regarding the at least one OVSF code tree.

4. The method of claim 3, further comprising a step of receiving mapping between the at least one OVSF code tree or information regarding the at least one OVSF code tree, and the received information.

5. A method performed in a network node of managing Orthogonal Variable Spreading Factor (OVSF) codes, the method comprising:
obtaining unused OVSF codes,
forming information regarding the unused OVSF codes, the information identifying the unused OVSF codes by unused OVSF code indices and/or Spreading Factors, SFs, and
transmitting the information regarding the unused OVSF codes to at least one User Equipment (UE), thereby enabling using unused OVSF codes in demodulation of signaling information received from the radio network by the at least one UE.

6. A User Equipment (UE) for a radio network comprising:
an antenna unit,
a receive unit and a transmit unit, connected to the antenna unit,
a memory unit, and a control unit arranged to control the function of the receive unit and the transmit unit,
wherein the receive unit is arranged to receive information regarding unused Orthogonal Variable Spreading Factor (OVSF) codes, and
wherein the control unit is arranged:
to obtain unused OVSF codes based on the information regarding unused OVSF codes, said unused OVSF codes being identified by at least one of: unused OVSF code indices and Spreading Factors (SFs).

7. The UE of claim 6, wherein the information regarding unused OVSF codes comprises at least one individual OVSF code index.

8. The UE of claim 6, wherein the information regarding unused OVSF codes comprises unused OVSF code pool indices or a subset of unused OVSF code pool indices.

9. The UE of claim 6, wherein the information regarding unused OVSF codes relate to at least one given Transmission Time Interval (TTI).

10. The UE of claim 6, wherein the information regarding unused OVSF codes comprises a Transmission Time Interval (TTI) for which the information regarding the unused OVSF code is applicable.

11. The UE of claim 6, having information related to at least one Transmission Time Interval (TTI) for which the information regarding the unused OVSF code is applicable.

12. The UE of claim 6, wherein the spreading factor (SF) is predefined.

13. The UE of claim 6, wherein the memory unit is arranged to store at least one of: at least one OVSF code tree; and information regarding the OVSF code tree.

14. The UE of claim 13, further having information related to mapping between the OVSF code tree or information regarding the OVSF code tree, and signalling values.

15. The UE of claim 14, further being arranged to receive the mapping information using higher-level signaling.

16. The UE of claim 6, wherein the control unit further is arranged to apply the unused OVSF codes in demodulation of signaling from a network.

17. A network node for a radio network, comprising a receive unit and a transmit unit controlled by means of a control unit, and a memory unit,
wherein the control unit has knowledge about unused Orthogonal Variable Spreading Factor (OVSF) codes at the moment or during coming Transmission Time Intervals (TTIs),
wherein the control unit is arranged to form information regarding unused OVSF codes based on the unused OVSF codes, the information regarding at least one of: unused OVSF codes identifying the unused OVSF codes by unused OVSF code indices; and Spreading Factors (SFs), and
wherein the transmit unit is arranged to transmit the information regarding the unused OVSF codes to at least one User Equipment (UE).

18. The network node according to claim 17, arranged to signal a first dedicated or common High Speed Shared Control Channel (HS-SCCH) order comprising the information regarding unused OVSF codes

19. The network node according to claim 17, arranged to signal a higher-level signaling comprising the information regarding unused OVSF codes

20. The network node according to claim 19, arranged to signal a first Radio Network Controller (RNC) Radio Resource Control (RRC) message comprising the information regarding unused OVSF codes

21. The network node according to claim 20, further having information related to mapping between the OVSF code tree or information regarding the OVSF code tree, and signaling values.

22. The network node according to claim 20, further being arranged to perform at least one of: transmit and receive the mapping information using higher-level signaling such as a second HS-SCCH order or second RNC RRC messages.

23. The network node according to claim 17, wherein the network node is a Node B.
